(19) United States
(12) Patent Application Publication
(10) Pub. No.: US 2020/0288677 A1
(43) Pub. Date: Sep. 17, 2020

(54) METHOD AND SYSTEM FOR THE MANAGEMENT OF PRODUCTION ANIMALS

(71) Applicant: Antoon Willem Johan CLAESSENS, Leunen (NL)

(72) Inventor: Antoon Willem Johan CLAESSENS, Leunen (NL)

(21) Appl. No.: 16/753,485

(22) PCT Filed: Oct. 6, 2018
(86) PCT No.: PCT/EP2018/077235

§ 371 Date: Apr. 3, 2020

(30) Foreign Application Priority Data
Oct. 6, 2017 (EP) 17075019.4

(51) Int. Cl. A01K 29/00; A01K 11/00; A01K 5/02; A61D 7/00

(52) U.S. Cl. CPC A01K 29/005; A61D 7/00; A01K 5/02; A01K 11/006

(57) ABSTRACT

A method for the management of a group of production animals kept in a confined space, includes at multiple points in time during the period wherein the animals are kept in the confined space, for each individual animal of the group, the automatic identification of the animal, establishment of a position the animal takes in the confined space, determination of a physical property of the animal, and the coupled storage of data corresponding to the identification, the position and the physical property in a memory that is operatively connected to the animal, and a system for applying this method and a device for using therein.

### TECHNICAL FIELD

The present invention pertains to a method and system for the management of production animals. In particular the invention pertains to a method and system that may automatically provide information with regard to the physical state of the animal, which information can be used to effectively manage the production animals, comprising optimizing output while meeting legal and animal welfare constraints.

### BACKGROUND INFORMATION

The management of production animals (live-stock) is largely automated these days, especially in the bio-industry. Feeding of the animals is highly automated as is climate control and other animal well-fare conditions. Also, monitoring of medical treatments is to an extent automated by using medicament administering and tracing methods and digital storage of these data, such as for example described in WO2013/110624 (assigned to Piglets Treatments Systems BV, The Netherlands). Also, technology to automatically monitor the growth of animals is known. For example, WO 2005/034618 (assigned to AB Svenska Matanalys, Sweden) discloses a method for monitoring the weight and other parameters of pigs in which method individual pictures are taken of each pig and simultaneously identification of the pigs is performed using data emitted by a chip in each pig. WO2014/026765 (assigned to Holscher & Leuschner GMBH & Co, Germany) discloses a method wherein a mobile 3D camera is used within a stable to establish for each pig data corresponding to the weight and meat quality.

Next to all of the above, methods are available to control the licenses of livestock keepers, transportation of the animals and other treatments.

In other words, for each different aspect in the keeping of production animals such as pigs, diary and beef cattle, fish, poultry etc. automated systems are in place to monitor and control parameters in order to make sure output is maximized within the bounds and meets of the law and contractual obligations.

### OBJECT OF THE INVENTION

Despite the high level of automation in the keeping of production animals there is still a need for a method and system that may automatically provide information with regard to the physical state of the animal, which information can be used i.e., to control distribution of the animals in the animals housing, medical and feed treatment of the animals, animal welfare and supply of the animals to other locations at the end of the production stage. In particular, there is a need for a method and system in which information relating to the growth of each individual animal is can be optimally used to control production and animal welfare.

There is further a need for a dedicated administration device for use in the present method and system to meet the concerns of the governmental organizations and consumers, in particular to provide guarantees regarding compliance with laws and licenses, animal welfare, medical treatment, quality labels etc.

### SUMMARY OF THE INVENTION

It was applicant's recognition that despite the high level of automation of various processes to manage production animals, the current methods and systems for tracing medicament's administered to an animal still fail to provide the kind of high integrity information that takes away the concerns by governmental organization and consumers over the compliance with laws, licenses, quality labels, correctness of the tracing of applied medicament's, and, in relation to this, the residual effects of the medicament's on the physiology of the consumer itself. There are several reasons why current methods and systems fail in this respect. Firstly, in the relatively short life of a production animal (typically six months for a pig, two years for a head of cattle) the animals go through various consecutive distinct production stages, each stage of production is highly complex in order to maximize output. Feed and medical treatment are optimized for each stage in the growth of an animal, and so is housing and other animal well fare conditions. However, applicant recognized that the monitoring of all this, despite the great amount of automation still depends largely on the assessment of a human operator, which on its turn depends not only on skill, level of education, but also on intuition and the time available for the assessment. In particular since the number of animals a farmer must raise to be profitable time constraints are increasingly high. Even if a farmer intends to be diligent in monitoring physical well-being, in particular animal growth, and the keeping records of all feed treatments, climate control parameters, medicament's administered to each and every animal, etc. etc. the logistics in keeping such records and the difficulty in combining data may make the task very difficult, time consuming and prone to mistakes. In particular the cost of labor is becoming an asset that is an increasingly consuming part of the tight profit margins, and thus, putting extra effort in this respect is hard to accomplish economically. All-in-all, this will not decrease the governments and consumers concerns about food safety, and hence, the theoretical premium for safe food can hardly be collected.

In view of all this, applicant has devised a method for the management of a group of production animals kept in a confined space, the method comprising at multiple points in time during the period wherein the animals are kept in the confined space, for each individual animal of the said group, the automatic identification of the animal, the automatic establishment of a position the animal takes in the confined space, the automatic determination of a physical property of the animal, and the automatic coupled storage of data corresponding to the identification, the position and the physical property in a memory that is operatively connected to the said animal.

Applicant recognized that after the automatic determination of data identifying the animal, data corresponding to a physical property of an animal (for example its weight) and the position the animal takes in the confined space (for example the position a piglets takes in a box in a stable), followed by the automatic combined storage of these data (i.e., storage such that the various data can be processed in combination), the basic means to enable animal management hardly dependent on human labor and intuition are provided. For example, the growth of the animal can be monitored automatically and the relation with the location in the animal housing can be automatically assessed. Applicant recognized that climate control, feed provision, disease induction etc. may depend heavily on the specific location on the animal housing, such a relation can be simply calculated, without needing to rely on the insight and gut-feeling of an operator or team of operators that inspect the animals on a day-to-day basis. Also, by keeping track of the combination of data over time, it is very easy to automatically monitor deviations even long before they are so pronounced that they are actually visible by visual inspection of an animal by a human operator. For example, the change of weight might still be positive for a particular animal (or a particular number of animals), but if the change is less than that of other animals present at another location, this may cause the system to automatically trigger an alarm or other type of warning to try and improve the weight gain for this animal. The operative connection between the coupled data and the animal is also an essential aspect of the present invention. This however does not mean that the data has to be stored in a memory physically connected to the animal. The operative connection does not need to be more than a link between the stored data and the animal, for example a unique identification number of the animal being present on an ear tag and in a memory that holds said data.

The invention is also embodied in system which comprises a confined space wherein the animals are kept, identification means to identify an individual animal present in the space, localization means to establish a position the animal takes in the confined space, determination means for the determination of a physical property of said animal, and memory means to store for said animal in combination data corresponding to the identity, position and physical property of the said animal at a point in time. In a practical embodiment of this system, the memory is comprised in a data storage unit that is at least partly physically connected to the animals, such as a chip that is present in an ear tag, an implant or bolus. This chip may comprise all relevant data or only part of the data, the other part being present in a remote part of the data storage unit such as for example a distant server.

The invention also pertains to a device for the administration of medicament's for use the method and a system according to the invention, wherein the device is characterized in that the operation of the device when administering a medicament to an individual animal, is controlled by said data corresponding to a physical property of the predetermined animal. For example, the device may automatically provide the right amount of the medicament (the right amount of antibiotic, vaccine, etc.) for the weight of the animal, or may even be blocked if the weight is such that the animal is due for slaughter and may no longer receive a particular medicament.

### DEFINITIONS

A production animal (also referred to as livestock) is any animal that is kept to raise meat, fiber, protein, milk, eggs, wool, skin or other products for use by humans, as opposed to companion animals which are kept for primarily for a person's company, protection, or entertainment. The keeping of production animals includes day-to-day care, selective breeding, and the raising of animals. Typical production animals are swine, bovine, fish, sheep and poultry.

A confined space can be any closed or semi-closed area designed to restrict, and preferably prevent, the free movement of an animal to an area outside of the confined space, such as a stable, paddock, fenced land, a container, sea pen etc.

A point in time means a particular moment or a limited time interval such as a few seconds or minutes.

Identification of an animal means that the animal can be identified as a unique animal, at least distinct from other animal present in the same group of animals. Data corresponding to an identification can be for example a name, a number etc.

The position an animal takes in a space at a certain point in time is the geographical location the said animal has in that space at that point in time. Data corresponding to a position can be a number or set of numbers (e.g. geographical codes) or any other means of identifying the location (such as for example a name of a box in a stable).

A physical property of an animal is any property than depends on the physical qualities of the animal. Such a property may be for example a dimension (length, height, width, volume), shape, weight, color, temperature, motion (ability to move and/or actually performed movements), any bodily fluid parameter, respiratory rate, composition of excretions (faces, urine, respiratory air and fluids, etc), but may even be as simple as “being present alive” in the confined space. Data corresponding to a physical property is typically a number or set of numbers, but may also be an operator (“Yes” or “No”) or any other denominator.

Medical treatment means the management and care of a subject animal to combat disease or disorder. Medical treatment in particular includes the use of prescription medicament's and wound closing devices such as surgical glue, sutures, and staples. Data corresponding to a medical treatment is typically the type and amount of medicament that is administered at a certain point in time, or any other medical operation performed on the animal at that point in time.

Feed treatment means the provision of food to an animal or to nourish as if by food. Data corresponding to feed treatment is typically the type and amount of food provided at a certain point in time.

Animal welfare means how an animal is coping with the conditions in which it lives. An animal is in a good state of welfare if it is healthy, comfortable, well nourished, safe, able to express innate behavior, and if it is not suffering from unpleasant states such as pain, fear, and distress. Parameters by which animal welfare can be measured are the general impression the animal provides, the presence of wounds, its ability to freely move, the number of dead animals in the neighborhood of the animal, the presence of bite marks etc.

Regulatory data are data provided by an independent committee to regulate activities or the use of certain products. Examples are marketing authorizations for medicament's (the EMA being an example of a committee that provides the regulatory data), quality labels such as “Biologisch” and “Demeter” (for which the European Committee is the independent committee), “Bio Suisse”, “Beter Leven”, “USDA Quality approved” etc, and licenses provided by governmental organizations such as a license to keep a number of animals, a license to produce an amount of dung or nitrogen, ammonia or other substance.

Data being coupled means that they are stored or presented in a combined way, such that they can be analyzed (automatically or by a human operator) for the presence of one or more operative relations. Coupled data is also referred to as shared data, i.e., data that can be processed in combination due to shared accessibility.

A medicament is any substance or composition of matter able to prevent, treat, ameliorate or cure a disease or disorder. Typical medicaments used for livestock are antibiotics, vaccines, anti-inflammatory agents, muscle-relaxants and other small molecule pharmaceuticals.

To connect operatively is to establish a working relationship between two parts.

A data storage unit is any unit that comprises means for storing data, such as an RFID chip, a magnetic chip or any other electronic memory, in particular for example an EEPROM, RAM, NVM or FLASH memory. The unit may be comprised in an identification means typically used for identification of a production animal such as an ear tag, implant, bolus or a combination of any of these.

Automatic means without operator intervention. An automatic action may however be operator initiated or ended.

### EMBODIMENTS OF THE INVENTION

In a first embodiment of the method according to the invention, in which embodiment during the time the animals are kept in the confined space, medical treatment is recorded for each of the said individual animals, data corresponding to the medical treatment of each individual animal is coupled to the data corresponding to the identification, position and physical property of said animal. It is recognized that it is highly advantageous to couple the data regarding medical treatment to the other data. This not only provides the option to try and recognize the existence of one or more relationships between the medical treatment, physical properties and position of the animal (for example: animals in box A receive a statistical higher amount of antibiotics throughout time, and grow slower right after weaning, might indicate a worse climate and/or local infection risk with a pathogen), but also provides the option for high integrity data storage of animal growth and medical treatment throughout an animal's lifespan. As an example, the coupled data could be stored in the said memory that is operatively connected to the animal. If this memory is present for example in an ear tag, at each time throughout its lifespan the physical data and medical treatment data can be easily assessed. Also, this embodiment enables a further preferred embodiment wherein the coupled data are automatically assessed in order to control future medical treatment of each individual animal. So not only is the coupled data and assessment thereof advantageously usable to control for example animal distribution within the housing, or climate control, by incorporating the medical treatment data and assessment of its relationship with the other data, the medical treatment on itself could be better controlled. For example, if a correlation is discovered between animal growth and medical treatment, a solution could be to try and alter the medical treatment instead of otherwise attacking the problem such as through altering the feed treatment.

In another embodiment wherein during the time the animals are kept in the confined space, feed treatment is recorded for each of the said individual animals, data corresponding to the feed treatment of each individual animal is coupled to the data corresponding to the identification, position and physical property of said animal. As with medical treatment, the same way and basically for the same reasons, feed treatment data can also be advantageously coupled to the data corresponding to the identification, position and physical property of said animal. This can be done in combination with the medial treatment data or without these data. Preferably, both these types of additional data are included in the determination and storage process in order to enable combined processing thereof. All these coupled data may be stored in the said memory that is operatively connected to the animal. Advantageously, the coupled data are automatically assessed to control future feed treatment of each individual animal. For example, if one find out that at a certain location in the stable animals after a period of slower growth are more prone to catching a certain disease, this problem might be overcome by locally dosing more feed during a certain period of time to try and prevent the slow growth.

Corresponding to additional use of the medical and/or feed treatment data, in an embodiment wherein during the time the animals are kept in the confined space, animal welfare is recorded for each of the said individual animals, characterized in that data corresponding to the animal welfare of each individual animal is coupled to the data corresponding to the identification, position and physical property of said animal. As with medical and feed treatment data, the same way and basically for the same reasons, animal welfare data can also be advantageously coupled to the data corresponding to the identification, position and physical property of said animal. This can be done in combination with the medial treatment data and/or feed treatment data or without these data. Preferably, all three these types of additional data are included in the determination and storage process in order to enable combined processing thereof. All these coupled data may be stored in the said memory that is operatively connected to the animal. Advantageously, the coupled data are automatically assessed to control future animal welfare of each individual animal. For example, currently climate control such as providing sufficient ventilation in pig stables is controlled based on the age of the piglets. However, it is far better to do this based on the weight of the piglets since the amount of ventilation actually needed depends on the total weight of the animals present. However, since it is practically undoable to weigh all animals each and every day, use is a made of standard growth curves for healthy piglets, simply assuming that the piglets grow according to the standard curve. If a physical parameter is measured based on which such a weight can be calculated (for example: the dimensions of a pig by taking one or more images), ventilation can be automatically controlled in an adequate manner. Also, this method can rule out operator mistakes such as forgetting to initialize the ventilation routine on day of birth. When controlling ventilation based on actual weight determination such mistakes can be ruled out.

In yet another embodiment of the method according to the invention, wherein the animals after being kept are supplied to a location outside of the confined space, the data corresponding to the identification and physical property of each individual animal, and optionally the data corresponding to the position and/or medical treatment and/or feed treatment and/or animal welfare are used to control the supply of each animal to the said location.

The current system enables timely and very accurate estimates of the number and type of animals to be ready in the (near) future for supply to the next stage in the production cycle, such as transportation, breeding, (further) growing, slaughter etc. Applicant recognized that this knowledge can be used to optimize and supply of the animals, in particular timely and adequate planning of transport to the next stage of production.

In still another embodiment of the method according to the invention the data (i.e., data corresponding to the identification, position and physical property of each individual animal, and optionally the data corresponding to the medical treatment and/or feed treatment and/or animal welfare) is automatically coupled with regulatory data pertaining to the management of the animals in the said confined space. This way, the option is provided to automatically check whether or not the keeping of the animals complies with all kinds of licenses or contracts with third parties or governmental organizations. For example, by coupling the data it can be easily assessed whether the keeping of the animals complies with a local license to keep a particular maximum number of animals, or a local license to produce dung, nitrogen or other substance, or for example a license to allow transport vehicles to load animals. However, this embodiment also provides the option to check whether medicaments are being used in compliance with marketing authorizations (the right amount, the right type of animal, the right age, in an allowed combination regime, respecting the waiting time for slaughter etc.). Also, automatic check of compliance with quality labels is very important to try and get consumers trust.

With this invention as a whole, a vast amount of data relevant for the management of production animals is made available in a comprehensive manner, allowing the coupling of data, combined processing and the search for relationships long before the results thereof become actually visible in the form of a negative production parameter to the human manager of the animals. This provides the general principle that automatic warnings can be generated, possibly with a proposed solution, when carefully keeping track of performance and other parameters when compared to predetermined norms or standards or when compared to actual results in other spaces where animals are kept or even other parts of one space where animals are kept. Anticipating and preventing actual production problems is always better and more economical then curing them.

It is also foreseen, potentially depending on the type of production animal, that instead of data corresponding to the position the animal takes in the confined space, in any embodiment an alternative type of data is being used, which may be related to that position, in particular data such as medical treatment data (i.e., data corresponding to medical treatment), or feed treatment data (i.e., data corresponding to feed treatment). For example, in a large dairy farm using milking machines (such as for example available from Lely, The Netherlands), it is acknowledged in line with the teachings of the invention, use is made of particular combined data regarding each unique animal. For example, if at a certain milking machine, at a particular time, a particular animal is going to be milked and at the same time, it is known what its medical treatment history is, optionally in combination with any of the other type of data mentioned here above, the operation of the milking machine might be controlled using the combined data. Based on these data it could for example be decided not to milk the cow, or for example, to milk the cow but keep the actual milk of this cow separated from other milk obtained using the machine, in particular when the cow has been treated with antibiotics. This embodiment in fact inherently uses the position information as the milking machines remain at a particular predetermined location in the confined space. Also, the present invention, just as a mere example, foresees that in a fish farm, medical treatment data could be preferred as a basic type of data over the position an animal has over time in the confined space.

### BRIEF DESCRIPTION OF THE DRAWING

FIG. 1 schematically shows a system according to the invention.

### EXAMPLE

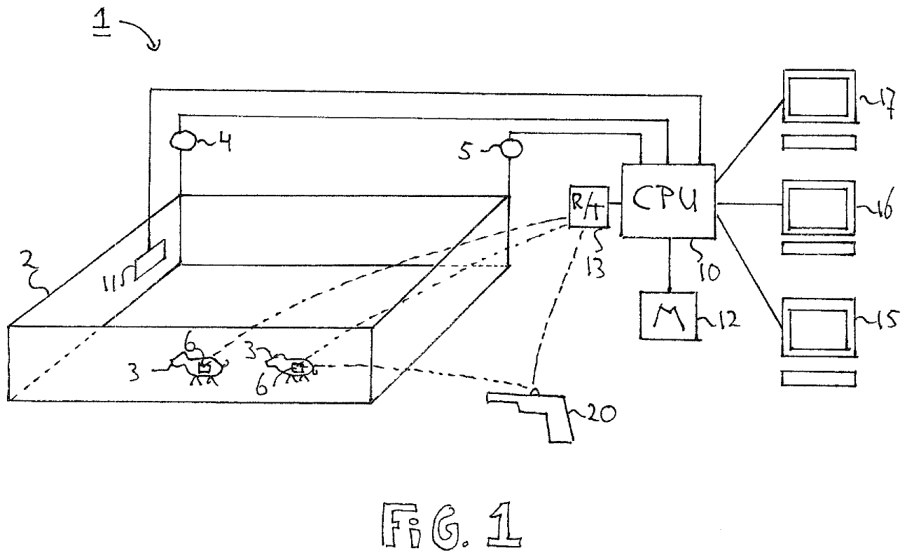

In FIG. 1 a system 1 according to the invention is schematically depicted. The system comprises a confined space 2, in this case a pig-stable, for the growing of weaned pigs (3, 3′). In the corners a respective wireless identification means 4 and determination means 5 are situated. The identification means can communicate in a wireless fashion with a chip 6 that is present in an ear tag of each of the animals. This way, all animals in the stable can be remotely identified. Determination means 5 in this particular embodiment is a high resolution camera with IR sensors, that is able to take images of each animal present at any location in the stable. Both the identification means 4 as well as the determination means 5 are operatively connected to central processing unit (CPU) 10. This unit controls the system as a whole. At various points in time, the CPU instructs to take images of the animals, for example of animals present at the feeding through 11 at a certain moment in time and then 2, 4, 6 and 8 hours later, repeated every day for 6 weeks in a row. The CPU also instructs the identification means to identify each animal at the moment it is imaged. The image can be used to determination one or more physical properties of the pigs, for example its weight and its temperature. Also, for each animal it is recorded how much feed is taken at the feeding through. The combined data is stored in memory 12 and in each chip. For this, the data is sent via receiver transmitter 13 to each chip.

In addition to these data, medical treatment data of each pig is also stored in memory 12 and the chips 6. For this, the veterinarian provides the data via computer 15. In an alternative embodiment all medicaments are provided using an administration device 20 that is capable of transmitting data regarding the medicament administered, while at the same time being able to identify the animal via communication with the chip 6. If so, medical treatment data can easily be automatically entered into memory 12 and chips 6 via receiver/transmitter 13 and stored in combination with (i.e., coupled to) the data obtained with means 4 and 5 and 11.

Also, animal welfare data for the pigs is stored in memory 12 and chips 6. For this, an operator provides the data via computer 16. In an alternative these data are provided using one or more automatic sensors (not depicted in FIG. 1) that are capable of transmitting the data regarding animal welfare to the CPU 10. In that case, welfare data can easily be automatically entered into memory 12 and chips 6 and stored in combination with (i.e., coupled to) the data obtained with means 4 and 5, 11 and 15.

Next to this, the stored data are also coupled with regulatory data pertaining to the management of the animals, which data is entered into the system via computer 17 (e.g. a computer at a medicines regulatory agency, a quality label agency, a governmental agency etc.)

What is claimed is:

1. A method for the management of a group of production animals kept in a confined space, the method comprising at multiple points in time during the period wherein the animals are kept in the confined space, for each individual animal of the group, the following steps
automatic identification of the animal,
automatic establishment of a position the animal takes in the confined space,
automatic determination of a physical property of the animal, and
automatic coupled storage of data corresponding to the identification, the position and the physical property in a memory that is operatively connected to the animal.

2. A method according to claim 1, wherein during the time the animals are kept in the confined space, further including the steps of:
recording medical treatment for each of the individual animals, and
coupling data corresponding to the medical treatment of each individual animal to the data corresponding to the identification, position and physical property of animal.

3. A method according to claim 2, further including the step of storing the coupled data in said memory that is operatively connected to the animal.

4. A method according to claim 3, further including the step of automatically assessing the coupled data to control future medical treatment of each individual animal.

5. A method according to claim 1, further including the steps of:
recording, during the time the animals are kept in the confined space, feed treatment for each of the individual animals, and
coupling data corresponding to the feed treatment of each individual animal to the data corresponding to the identification, position and physical property of said animal.

6. A method according to claim 5, further including the step of storing the coupled data in said memory that is operatively connected to the animal.

7. A method according to claim 6, further including the step of automatically assessing the coupled data to control future feed treatment of each individual animal.

8. A method according to claim 1, further including the steps of:
recording, during the time the animals are kept in the confined space, animal welfare for each of the individual animals, and
coupling data corresponding to the animal welfare of each individual animal to the data corresponding to the identification, position and physical property of said animal.

9. A method according to claim 8, further including the step of storing the coupled data in said memory that is operatively connected to the animal.

10. A method according to claim 9, further including the step of automatically assessing the coupled data to control future animal welfare of each individual animal.

11. A method according to claim 1, further including the steps of:
supplying the animals, after being kept, to a location outside of the confined space, and
using the data corresponding to the identification and physical property of each individual animal, to control the supply of each animal to said location.

12. A method according to claim 1, further including the step of automatically coupling the stored data with regulatory data pertaining to the management of the animals in said confined space.

13. A system for applying the method according to claim 1, wherein in that the system comprises:
a confined space wherein the animals are kept,
an identification device to identify an individual animal present in the space,
a localization device to establish a position the animal takes in the confined space,
a determination device for the determination of a physical property of said animal, and
a memory to store for said animal in combination data corresponding to the identity, position and physical property of the animal at a point in time.

14. A system according to claim 13, wherein the memory is comprised in a data storage unit that is at least partly physically connected to the animals.

15. A device for the administration of medicaments for use in the method according to claim 1, wherein operation of the device when administering a medicament to a predetermined animal, is controlled by said data corresponding to a physical property of the individual animal.

16. A method according to claim 11, wherein the step of using the data corresponding to the identification and physical property of each individual animal, uses data corresponding to at least one of:
the position,
medical treatment,
feed treatment and
animal welfare
to control the supply of each animal to said location.
